(19) United States
(12) Patent Application Publication
(10) Pub. No.: US 2025/0367883 A1
(43) Pub. Date: Dec. 4, 2025

(54) LOWER-LEVEL FINITE ELEMENT ANALYSIS MESH HOMOGENIZATION FOR SIMULATION OF ADDITIVE MANUFACTURING

(71) Applicant: PANOPTIMIZATION, LLC, State College, PA (US)

(72) Inventor: Panagiotis MICHALERIS, State College, PA (US)

(73) Assignee: PANOPTIMIZATION, LLC, State College, PA (US)

(21) Appl. No.: 18/921,081

(22) Filed: Oct. 21, 2024

Related U.S. Application Data
(60) Provisional application No. 63/654,851, filed on May 31, 2024.

(51) Int. Cl. B29C 64/393; B33Y 50/02; G06T 17/20

(52) U.S. Cl. CPC B29C 64/393; B33Y 50/02; G06T 17/20

(57) ABSTRACT

A method of predicting thermal response, mechanical response, and/or failure points in additive manufacturing, including generating a first layer of a finite element mesh of an object based on a three-dimensional model of the object; generating one or more additional layers of the finite element mesh of the object; homogenizing one or more lower layers of the finite element mesh when the one or more lower layers are located at a distance greater than a distance threshold from a most recently added layer of the finite element mesh; simulating an additive manufacturing build of the object based on the finite element mesh including the homogenized one or more lower layers, wherein a length of a homogenized element in the homogenized one or more lower layers is greater than a maximum element length in the finite element mesh prior to homogenization, and the distance threshold is a positive real number.

### CROSS-REFERENCE TO RELATED APPLICATIONS

The present application claims priority to U.S. Provisional Application No. 63/654,851, filed May 31, 2024, which is incorporated herein by reference in its entirety for all purposes.

### TECHNICAL FIELD

The present disclosure relates to simulation and optimization of additive manufacturing builds.

### BACKGROUND

Additive manufacturing (AM) and welding of parts frequently result in residual stress-induced failures (e.g., loss of dimensional accuracy, cracking, and printer jams) due to the plastic deformation, metallurgical transformations, and thermal cycles that are inherent to the process. Finite element models are commonly used to simulate and predict these thermomechanical issues prior to manufacturing. Simulation runtimes and memory consumption increase cubically as model size increases, meaning that parts become increasingly difficult to simulate as they become larger and/or more complex.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

In one embodiment, the present disclosure is related to a method of predicting thermal response, mechanical response, and/or failure points in additive manufacturing, the method comprising generating a first layer of a finite element mesh of an object based on a three-dimensional model of the object; generating one or more additional layers of the finite element mesh of the object; homogenizing one or more lower layers of the finite element mesh when the one or more lower layers are located at a distance greater than a distance threshold from a most recently added layer of the finite element mesh; simulating an additive manufacturing build of the object based on the finite element mesh including the homogenized one or more lower layers, wherein a length of a homogenized element in the homogenized one or more lower layers is greater than a maximum element length in the finite element mesh prior to homogenization, and the distance threshold is a positive real number.

In one embodiment, the present disclosure is related to an apparatus for predicting thermal response, mechanical response, and/or failure points in additive manufacturing, the apparatus comprising processing circuitry configured to generate a first layer of a finite element mesh of an object based on a three-dimensional model of the object, generate one or more additional layers of the finite element mesh of the object, homogenize one or more lower layers of the finite element mesh when the one or more lower layers are located at a distance greater than a distance threshold from a most recently added layer of the finite element mesh, and simulate an additive manufacturing build of the object based on the finite element mesh including the homogenized one or more lower layers, wherein a length of a homogenized element in the homogenized one or more lower layers is greater than a maximum element length in the finite element mesh prior to homogenization, and the distance threshold is a positive real number.

In one embodiment, the present disclosure is related to a non-transitory computer-readable storage medium for storing computer readable instructions that, when executed by a computer, cause the computer to perform a method, the method comprising generating a first layer of a finite element mesh of an object based on a three-dimensional model of the object; generating one or more additional layers of the finite element mesh of the object; homogenizing one or more lower layers of the finite element mesh when the one or more lower layers are located at a distance greater than a distance threshold from a most recently added layer of the finite element mesh; simulating an additive manufacturing build of the object based on the finite element mesh including the homogenized one or more lower layers, wherein a length of a homogenized element in the homogenized one or more lower layers is greater than a maximum element length in the finite element mesh prior to homogenization, and the distance threshold is a positive real number.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a geometry of an object that can be fabricated using additive manufacturing according to one embodiment of the present disclosure;

FIG. 1B is a mesh of an object for simulating additive manufacturing according to one embodiment of the present disclosure;

FIG. 1C is a mesh of an object for simulating additive manufacturing according to one embodiment of the present disclosure;

FIG. 1D is a mesh of an object for simulating additive manufacturing according to one embodiment of the present disclosure;

FIG. 1E is a mesh of an object for simulating additive manufacturing according to one embodiment of the present disclosure;

FIG. 1F is a mesh of an object for simulating additive manufacturing according to one embodiment of the present disclosure;

FIG. 2 is a computer-aided design schematic of a heat exchanger according to one embodiment of the present disclosure;

FIG. 3 is an illustration of simulated additive manufacturing of a heat exchanger according to one embodiment of the present disclosure;

FIG. 4 is a graph of FEA node count as a function of number of simulation layers according to one embodiment of the present disclosure;

FIG. 5 is an illustration of mechanical simulation of a heat exchanger according to one embodiment of the present disclosure;

FIG. 6 is a method of simulating additive manufacturing with lower-layer homogenization according to one embodiment of the present disclosure; and

FIG. 7 is a schematic of a hardware system for performing a method according to one embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

In one embodiment, the present disclosure is directed to lower-level mesh homogenization for finite element analysis. Three-dimensional (3D) modeling can be used to characterize objects that are fabricated through additive manufacturing methods. The modeling can include determining characteristics of an object and simulating a layered (additive) build process. Additive manufacturing processes can include, but are not limited to, 3D printing, laser powder bed fusion (L-PBF), direct metal laser sintering (DMLS), and selective laser melting (SLM), and other metal or nonmetal processes. The additive manufacturing process can result in the formation of microstructures in an object. The placement of the microstructures can depend on the geometry of the object and variation in cooling of the object's layers as they are formed. The microstructures can affect the mechanical properties of a fabricated objects. Additive manufacturing processes also result in formation of residual stress and a specific thermomechanical response in the deposited material. The residual stress can impact the geometric tolerance of an object.

Simulation of a build process can be used to identify where microstructures will form in an object and characterize the mechanical properties of the object during and after fabrication. Simulation of the build process can also be used to characterize residual stress and distortion resulting from the additive manufacturing process. Said simulation can be based on a mesh of the object.

In one embodiment, thermomechanical simulation and analysis of the build process of an object can be used to determine material properties, temperature history, distortion, and residual stress state of the object. Simulation of the build process can include simulating additions of each layer of a three-dimensional mesh representing the object. For example, in L-PBF, the object is manufactured by melting and fusing material in a powder form using a laser beam (or electron beam). The laser beam melts the powder in a specific pattern, and each layer of melted powder in the pattern fuses with the existing fused layers to add to the object in a build direction (e.g., vertically). L-PBF can use very small lasers to achieve thin or finely detailed objects with very high material density. Simulation of the build process can include analysis of the object's thermal and mechanical response and/or material properties as each layer is added. The simulation can include a temporal component to model how quickly a layer is fabricated and the temperature and distortion of materials change over time as a layer forms and cools. The object can be a heterogeneous material, e.g., a composite material.

An accurate simulation of the additive manufacturing process can reduce the need for repeated physical testing of fabricated objects, which can be expensive and destructive. A simulation also provides a more comprehensive analysis of an object at greater resolution than physical testing, which often only focuses on select points of failure. In one embodiment, the processes described herein can be used to determine mechanical, diffusive, thermal, or electrical properties and thermomechanical responses of an object via finite element analysis, as well as failure points resulting from the material properties and thermomechanical response. These properties can be anisotropic and can be tensor-valued, e.g., stress tensor, strain tensor, elasticity tensor. Directional heat flow during additive manufacturing can result in a significant thermal gradient, which can cause deformation and stress and introduce variation in material properties throughout an object.

Different material properties can be determined via simulation at different scales. For example, microstructure evolution and fluid dynamics of molten pools can be determined at micron-level scale; however, this analysis cannot be scaled effectively for most manufactured objects. As the scale increases, different modeling assumptions can be implemented to simplify or generalize certain material dynamics, such as the effect of a heat source (e.g., high energy laser beam). The analysis can include modeling materials (e.g., a metal) at different states (e.g., powder, solid, liquid), wherein the materials can have temperature-dependent properties in each state. In one embodiment, the analysis can include effects of material solidification and evaporation, which can cause layer shrinkage. In one embodiment, the analysis can be based on microstructure formation in the materials. For example, a heterogeneous material can have periodic microstructures. The distribution of the microstructures can affect the formation and homogenization of the object mesh. In one embodiment, the simulation can include modeling the actual material(s) of the object as one or more different materials. For example, the simulation can include modeling a heterogeneous region as a representative homogeneous region (e.g., asymptotic homogenization) when the difference in properties between the materials of the two regions is taken into account in the modeling.

In one embodiment, analysis of a mesh when a new layer is added in a simulation can include not only analysis of the new layer but also analysis of the mesh as a whole as a result of the addition of the new layer. When the additive manufacturing simulation is complete, the determined material properties and thermomechanical response can be used to model and assess the temperature, distortion, and stress and strain profile of the object, as well as derivative properties of the object such as elasticity (Young's modulus), Poisson ratio, shear modulus, yield strength, tensile strength, and fatigue.

Determination of the properties can be complex and can require a large amount of processing power to model the addition of each layer in the build, especially for objects with complex or large geometries. These objects can have nodes on the order of millions to billions. Therefore, it can be beneficial to reduce the complexity of a three-dimensional mesh while preserving resolution of fine geometric details and features in the mesh for accurate modeling.

In one embodiment, finite element analysis (FEA) (also referred to as the finite element method (FEM)) can be applied to a discretized three-dimensional mesh of an object to determine thermomechanical response and material properties of the object. The mesh can be composed of elements of any shape that can form a mesh, including, but not limited to, cubes, hexahedron cells, tetrahedron cells, etc. The mesh can be referred to as a finite element mesh or voxel mesh. In one embodiment, FEA can be applied to solve a number of equations (e.g., boundary conditions) describing material behaviors or properties in an object. In one embodiment, the material behaviors or properties can be determined based on the additive manufacturing process (e.g., the rate of layer formation) and/or material phase, which can be time-dependent. In one embodiment, the boundary conditions can describe a deformation gradient, stress, strain, etc.

The coarseness (e.g., size of voxels) of meshes used in FEA can affect the efficiency and accuracy of a simulation. For example, analysis of large voxels can be faster but may result in inaccurate assessment due to the high level of generalization and omission of fine features, while analysis of smaller voxels may result in more accurate characterization of variations in material properties and thermomechanical response but can require more computation time and power. The accuracy of FEA using a voxel of a certain size can also depend on where the voxel is located within the mesh of the object as a whole. The structure and geometry of the object itself can affect the degree of homogenization that is appropriate for accurate analysis.

In one embodiment, the present disclosure is directed to systems and methods for lower-level mesh homogenization for FEA. The method can be applied to iteratively coarsen lower layers of voxels in a mesh as new layers of the mesh are added to simulate an additive manufacturing process. Typically, continued FEA of a mesh increases exponentially (e.g., cubically) as more layers of the mesh are added, which can make accurate simulation of large or complex geometries extremely computationally intensive. There is an opportunity for increased efficiency in FEA by homogenizing lower layers of a mesh based on a relationship between the lower layers and upper (new or newly added) layers. In this manner, certain fine geometric features of the mesh can be preserved for FEA even as a mesh scales in size. Notably, fine geometric features of upper layers can be preserved for initial analysis of said upper layers.

In one embodiment, homogenization of finite elements as described herein can refer to a process of coarsening (merging, grouping, forming a representative element, etc.) of finite elements (e.g., a voxel) such that the homogenized finite elements in a mesh become larger than a geometric feature of interest. It can be appreciated that homogenization can be applied to different types of finite elements and with various coarsening methods and that the specific elements and coarsening techniques described herein are presented as non-limiting examples.

In one embodiment, a lower layer (or level) of a mesh can include any layer of the mesh that is not an uppermost layer. The mesh can be composed of voxels, wherein a voxel of the mesh can have a minimum voxel side length (x). In one embodiment, the minimum voxel side length (x) can be determined based on the additive manufacturing process. For example, the minimum voxel length can correspond to a discrete unit of material that is formed or deposited via an additive manufacturing process. In L-PBF, a unit of material can correspond to the size of the laser beam or a powder particle size. In one embodiment, the minimum voxel side length (x) can be based on a feature size, e.g., a minimum feature size of the object or a minimum feature size that is achievable by the additive manufacturing process.

As layers of the mesh are added in a build direction (or along a build axis), the lower layers can be assessed to determine whether any voxels in the lower layer can be homogenized. As an example, the build direction can be a vertical direction, as in certain 3D printing processes. In one embodiment, a lower layer can be eligible for homogenization when the lower layer is located at a distance greater than a distance threshold from the uppermost layer of the mesh. In one example, the distance threshold can be 2^{N}xb from the uppermost layer of the mesh. N can be a positive integer. In one embodiment, N can be a maximum number of coarsening generations (iterations). b can be a positive integer. In one embodiment, the values of N and b can be defined based on a desired resolution of the homogenized mesh and FEA results (e.g., material properties or object properties). For example, greater N values and/or greater b values can result in slower homogenization of layers and fewer layers that are ultimately homogenized when the additive manufacturing is complete.

In one embodiment, a coarsened voxel can have a maximum size. The maximum size can be based on the maximum number of coarsening generations N. For example, when the voxels are cubes, a coarsened voxel can have a maximum side length of 2^{N}x. Prior to homogenization, a voxel size can be constrained by the geometry of an object. For example, the maximum dimension (e.g., width) of a unit voxel at a first coarsening generation can be the corresponding dimension (e.g., width) of the object at the location of the voxel.

In a coarsening process, voxels can be combined to form a coarsened voxel that is larger than the original voxels making up the coarsened voxel. The larger voxel can then be treated as an element for FEA, resulting in fewer total elements that need to be analyzed. In one embodiment, layers that meet the criteria of being 2^{N}xb from the uppermost layer can be homogenized iteratively as each new layer is added. For example, two adjacent lower layers can each be homogenized in a first coarsening generation. The homogenization in the first coarsening generation can be limited to coarsening of voxels within each layer. In a second coarsening generation, the two adjacent lower layers can be further homogenized such that voxels across the two adjacent lower layers are combined. At each coarsening generation, the mesh can be analyzed as a whole to determine the object properties at that point in the additive manufacturing process and the behavior of new layers. The material properties and behavior of the object when the lower layers were initially formed are determined and preserved during that initial formation. The resolution of the lower layers becomes less critical as more layers are added to the mesh because the lower layers (that meet a criterion as described herein) have a limited impact on the mechanical response in the uppermost layers.

Voxels in the mesh can be coarsened via various homogenization techniques. In coarsening, adjacent voxels can be combined and modeled as a larger (coarsened) element. As an example, the coarsened voxel can be a beam having a first dimension (e.g., length) that is significantly greater than remaining dimensions (e.g., height, depth). In one embodiment, the coarsened voxel can depend on the original shape of the individual voxels.

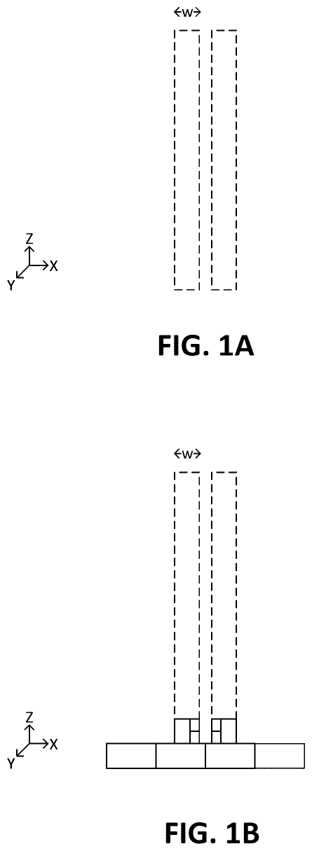

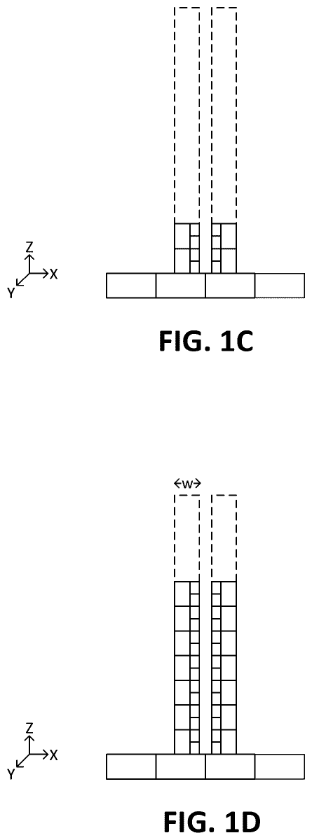

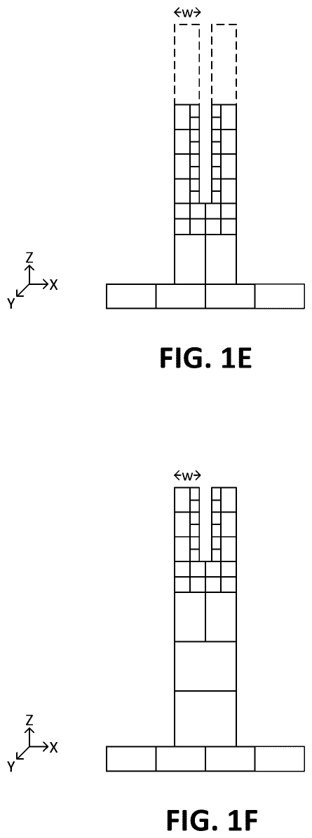

FIG. 1A through FIG. 1F illustrate a coarsening process of an object according to one embodiment. As illustrated in FIG. 1A, the object can include two parallel bars each having a width w. The mesh of the object can be composed of voxels. The object can be fabricated via an additive manufacturing process by adding layers or layer groups to the object in the positive z direction (the build direction), e.g., vertically. FIG. 1B illustrates a first layer of the mesh 100 on a substrate according to one embodiment. The voxels of the mesh can follow an octree scheme, wherein a feature (e.g., a parallel bar) of the mesh is recursively subdivided into octants and an octant having a minimum voxel side length (x) can be a voxel. In one embodiment, each voxel can contain or be associated with a node defined by a coordinate location in space to represent the geometry of the object. In one embodiment, the voxels can vary in size, as illustrated in FIG. 1B. The mesh of FIG. 1B only has a single layer group and therefore does not have any layers that are 2^{N}xb from the uppermost layer available for coarsening.

FIG. 1C is an illustration of a second layer group added to the mesh via additive manufacturing according to one embodiment. The mesh of FIG. 1C still does not have any layers that are 2^{N}xb from the uppermost layer available for coarsening. FIG. 1D is an illustration of the mesh having seven layer groups. None of the seven layer groups of the mesh in FIG. 1D are available for coarsening according to the example criteria of being 2^{N}xb from the uppermost layer.

FIG. 1E is an illustration of the mesh with eight layer groups according to one embodiment. Upon the addition of the eighth layer group, lower layers of the mesh are available for coarsening. For example, FIG. 1E illustrates that the voxels of the two lowest layers are coarsened into a single layer of two adjacent coarsened voxels. The voxels of the third and fourth lower layers of the mesh are coarsened into quadrants that are larger than the original (octant) voxels. In one embodiment, the number of layers that can be coarsened can be defined by a positive integer (c). For example, in FIG. 1E, two coarsening generations (the first and second layer, and the third and fourth layers) are allowed once the layers are eligible for coarsening.

FIG. 1E illustrates that the coarsened voxels do not need to preserve the exact geometry of the object. For instance, the four coarsened lower layers form a continuous block of coarsened voxels rather than maintaining the two distinct parallel bars of the mesh. FIG. 1F illustrates a final mesh for FEA according to one embodiment. Lower layers of the mesh can be fully coarsened such that the base of the two parallel bars is formed by a single coarsened voxel with a height of four layers. In one embodiment, the size of the coarsened voxels can be constrained, as described herein. The final mesh can be used for a transient thermal analysis and/or quasi-static structural analysis, e.g., to determine displacement, stress, strain, etc. of the object as a whole when transient loads are applied.

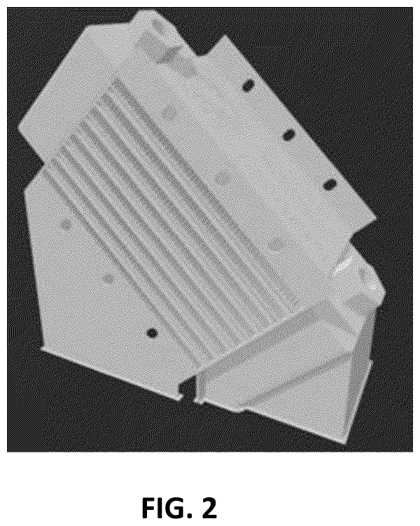

The methods described herein can be applied for analysis of large objects having complex geometries and fine features. For example, FIG. 2 is a schematic of a heat exchanger that can be printed with a metal 3D printer. The heat exchanger can be approximately 200 millimeters (mm) by 120 mm by 200 mm and includes fine features, such as the arrays of vanes each having a width of approximately 300 microns. The layers of the heat exchanger can be formed by a laser that selectively melts metal powder in the shape of the heat exchanger in a direct metal laser sintering process. The pattern of the laser can be automatically set according to a schematic or model (e.g., computer-aided design (CAD) model) of the heat exchanger. It can be advantageous to efficiently simulate the additive manufacturing process in order to predict build issues that may occur during the additive manufacturing.

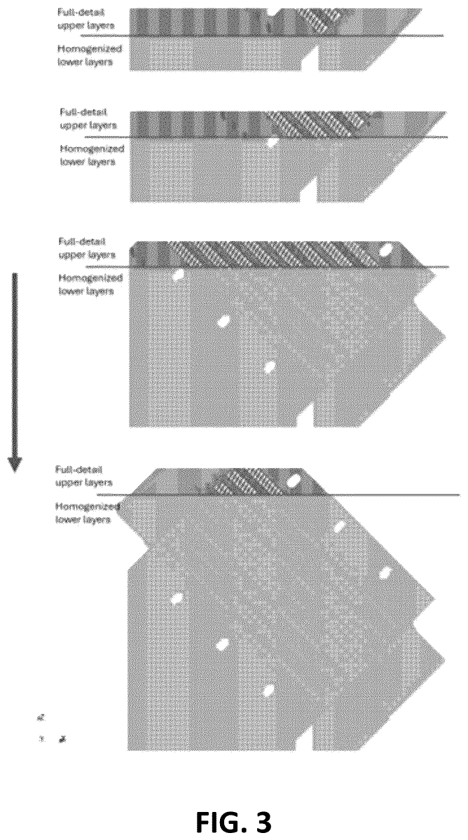

FIG. 3A through FIG. 3D are voxel meshes of the heat exchanger of FIG. 2 at different points in a simulated additive manufacturing process. As layers or layer groups are added to the mesh in the build direction (e.g., vertical direction), lower layers can be homogenized in an iterative process as described herein. The lower layers that are homogenized in a given coarsening generation can be a certain distance away from the uppermost layer that is formed. As an example, the distance can be based on the geometry of the heat exchanger and the size of the original unit voxels. As FIG. 3A illustrates, the homogenized voxels in the lower layers can be larger than the voxels of the full-detail upper layers. The homogenized voxels can be limited by a maximum dimension. In one embodiment, the sizes of homogenized voxels can vary based on the features of the object, e.g., size of features that are represented by the homogenized voxels, empty space, etc.

FIG. 3B illustrates continued addition of layers to the mesh. Upper layers can be maintained in non-homogenized form, while lower layers can be newly homogenized at a certain distance from the uppermost layer. The homogenized lower layers were previously modeled in full detail in FIG. 3A. FIG. 3C and FIG. 3D further illustrate continued addition of layers to the mesh. In the mesh of FIG. 3C, it can be important to maintain full detail of the array of vanes while the array is being formed by active material deposition. As more layers are added, the vanes and other details of lower layers can be simplified (bridged) in larger voxel representations because those features become more stable over time and do not affect the upper layers. The coarsening can occur automatically based on the set parameters related to coarsening criteria and voxel size, thus requiring no user interaction during the mesh-building process.

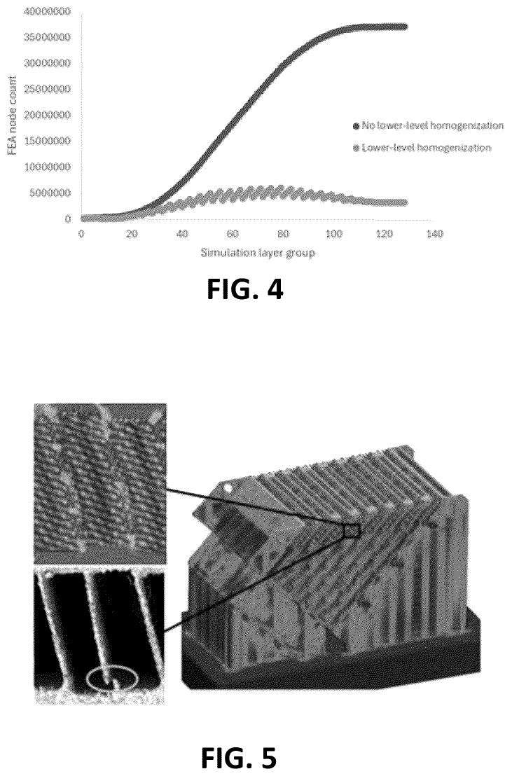

FIG. 4 is a graph of FEA node (e.g., voxel) count in the mesh as a function of the number of simulated layers that are added to the mesh. Without lower-level homogenization, the number of nodes increases exponentially with the number of layers added. With lower-level homogenization, the number of nodes is relatively consistent and even decreases as the final layers of the mesh are added. FIG. 4 shows that the lower-level homogenization method presented herein is very effective at reducing node count in the mesh, which can result in increased computational efficiency of the simulation.

The mesh that is generated as a result of the additive manufacturing simulation can be used in conjunction with a thermal and/or mechanical simulation to predict build issues in a real additive manufacturing process. FIG. 5 is an illustration of the homogenized mesh of the heat exchanger being used to simulate von Mises stress on the heat exchanger. The mechanical simulation can indicate that a crack may occur in an upper portion of the heat exchanger as a result of high stress. In the example of FIG. 5, the simulation of high stress is validated by an observed crack at the same location in a real heat exchanger that is printed via DMLS. The homogenized mesh of FIG. 3A through FIG. 3D can be used to effectively model and predict thermomechanical response and/or properties of the object during and after additive manufacturing.

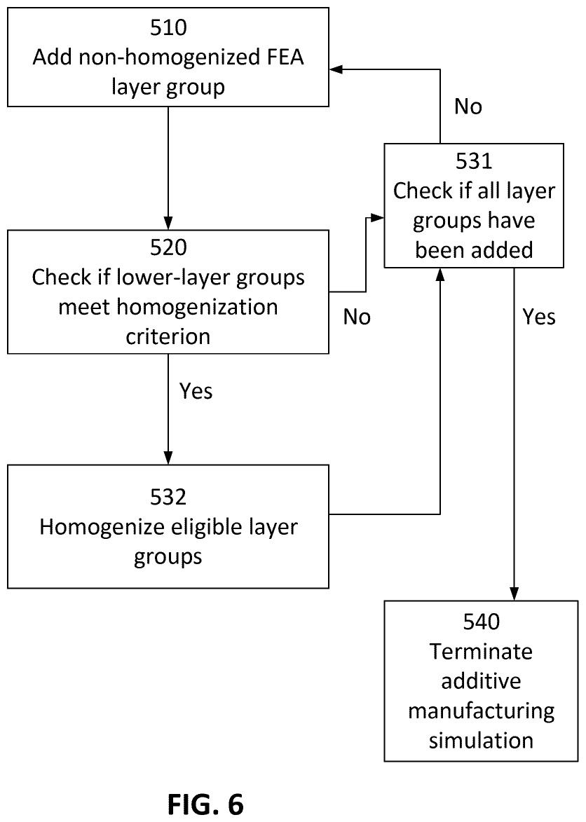

FIG. 6 is a flowchart of a lower-level homogenization method, according to one embodiment. Initially, a non-homogenized FEA layer group of elements (e.g., voxels) can be added to the mesh at step 510. At step 520, the mesh can be assessed to determine if any lower-layer groups meet the homogenization criterion. The homogenization criterion can be a pre-determined parameter that is based on the object being manufactured and/or the additive manufacturing process. In one embodiment, the homogenization criterion can be adaptive and can vary spatially or temporally throughout the additive manufacturing process.

When lower-layer groups do not meet the homogenization criteria, the method can proceed to step 531, wherein the mesh is assessed to determine if all layer groups have been added. When the mesh is complete with all layer groups, the method can terminate at step 540. When the mesh is not complete, the method can proceed back to step 510 and another non-homogenized FEA layer group can be added to the mesh. The method can then repeat until the mesh is complete.

When a lower-layer group meets the homogenization criterion, the method can proceed to step 532, wherein the eligible lower-layer groups are homogenized. The method can then proceed to step 531 wherein the mesh is assessed to determine if all layer groups have been added. When the mesh is complete with all layer groups, the method can terminate at step 540. When the mesh is not complete, the method can proceed back to step 510 and another non-homogenized FEA layer group can be added. The method can then repeat until the mesh is complete.

Further details about the mechanical simulation of the AM build process based on the meshes described herein can be found in Dong, Wen, et al. “A new procedure for implementing the modified inherent strain method with improved accuracy in predicting both residual stress and deformation for laser powder bed fusion,” Additive Manufacturing 47 (2021): 102345; Lindgren, Lars-Erik, and Andreas Lundbäck; “Approaches in computational welding mechanics applied to additive manufacturing: Review and outlook,” Comptes Rendus. Mécanique 346.11 (2018): 1033-1042; Chen, Qian, et al. “An inherent strain based multiscale modeling framework for simulating part-scale residual deformation for direct metal laser sintering,” Additive Manufacturing 28 (2019): 406-418; Bayat, Mohamad, et al. “A review of multi-scale and multi-physics simulations of metal additive manufacturing processes with focus on modeling strategies,” Additive Manufacturing 47 (2021): 102278; and Gouge, Michael, et al. “Experimental validation of thermo-mechanical part-scale modeling for laser powder bed fusion processes,” Additive Manufacturing 29 (2019): 100771, each of which is incorporated herein by reference in its entirety for all purposes.

The homogenized mesh described herein can be used for an additive manufacturing build. For example, a homogenized mesh can be used to simulate the process of fabricating an object using additive manufacturing. The simulation can identify issues in the additive manufacturing process, and the object and/or the additive manufacturing process can be modified in order to prevent said issues in a real build. In one example, the geometry of the object can be modified based on the homogenized mesh to improve the strength of the object. In one example, supports or scaffolds can be added to the object based on the homogenized mesh in order to stabilize the object during the additive manufacturing process. The modifications can be incorporated into an updated model (e.g., mesh) of the object.

In one embodiment, the method of FIG. 6 can further include fabricating the object using an additive manufacturing process based on the homogenized mesh generated in steps 510-532. In one embodiment, a manufacturing mesh can be generated based on the homogenized mesh. The manufacturing mesh can be an input to an additive manufacturing device to control the fabrication process. For example, the manufacturing mesh can be part of a design file such as an STL file that is used to program an additive manufacturing device. In one example, a laser can be used for additive manufacturing of metal objects. The additive manufacturing device can be, for example, a laser powder bed fusion (L-PBF) device, a direct metal laser sintering (DMLS) device, a selective laser melting (SLM) device, etc. The additive manufacturing device can include a laser that is configured to move across layers of metal material in order to fabricate the object. The movement of the laser beam can follow a path or pattern that is based on the manufacturing mesh. In one embodiment, the manufacturing mesh can be the homogenized mesh. In one embodiment, the manufacturing mesh can be a fine mesh version of the homogenized mesh. The manufacturing mesh can be generated and/or updated according to the simulation of the homogenized mesh. The manufacturing mesh can be used to fabricate an object that will have the material properties that are determined by simulation using the homogenized mesh.

Examples of compatible additive manufacturing processes that can be performed based on or using the adaptive fine mesh of the present disclosure can be found in Tebianian, et al. “A review of the metal additive manufacturing processes,” Materials 16(24) (2023): 7614.

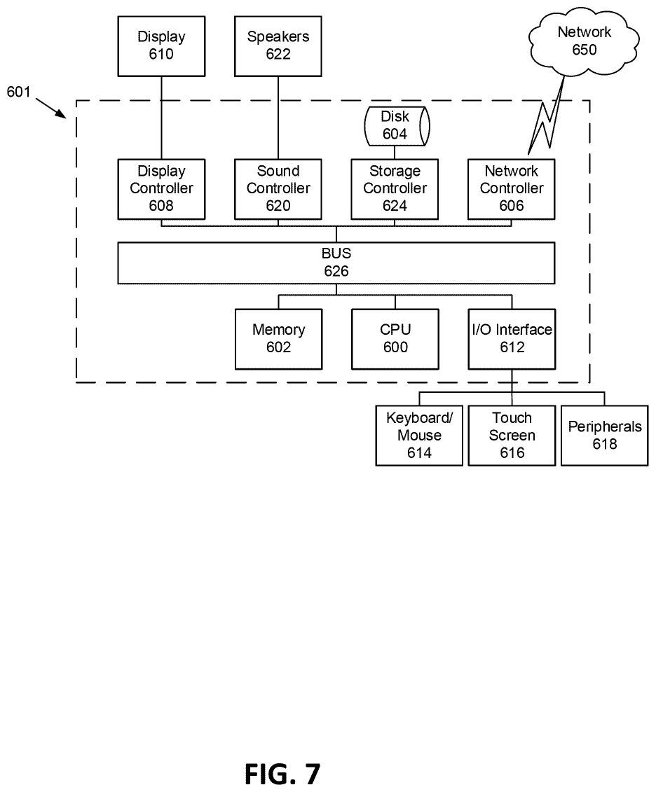

Next, a hardware description of a device 601 according to embodiments is described with reference to FIG. 7. In FIG. 7 the device 601 includes processing circuitry. The device 601 can be used to execute any of the methods described herein related to simulating or controlling additive manufacturing, homogenizing layers in a mesh, performing FEA, determining material properties of an object, etc. In one embodiment, the device 601 can be a server, a computer, etc. In one embodiment, the device 601 can be in communication with or embedded in an additive manufacturing device, such as an AM printer. The device 601 can receive user input regarding coarsening parameters, such as a minimum or maximum voxel size, coarsening criteria, coarsening method, etc. In one embodiment, the methods described herein can be distributed across one or more devices, the one or more devices including at least some of the elements of device 601. The processing circuitry includes one or more of the elements discussed next with reference to FIG. 7. The process data and instructions for performing the methods described herein may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 601 communicates, such as a server or computer.

Further, the claimed advancements may be provided as a utility application, background daemon, or component of an operating system, or combination thereof, executing in conjunction with CPU 600 and an operating system such as Microsoft Windows, UNIX, Solaris, LINUX, Apple MAC-OS and other systems known to those skilled in the art.

The hardware elements in order to achieve the device 601 may be realized by various circuitry elements, known to those skilled in the art. For example, CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the processes described above.

The device 601 in FIG. 7 also includes a network controller 606, such as an Intel Ethernet PRO network interface card from Intel Corporation of America, for interfacing with network 650. and to communicate with the other devices. As can be appreciated, the network 650 can be a public network, such as the Internet, or a private network such as an LAN or WAN network, or any combination thereof and can also include PSTN or ISDN sub-networks. The network 650 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device 601 further includes a display controller 608, such as a NVIDIA GeForce GTX or Quadro graphics adaptor from NVIDIA Corporation of America for interfacing with display 610, such as an LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners. A sound controller 620 is also provided in the device 601 to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the device 601. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Embodiments of the present disclosure may also be set forth in the following parentheticals.

(1) A method of predicting a thermal response, a mechanical response, and/or failure points in additive manufacturing, the method comprising: generating a first layer of a finite element mesh of an object based on a three-dimensional model of the object; generating one or more additional layers of the finite element mesh of the object; homogenizing one or more lower layers of the finite element mesh when the one or more lower layers are located at a distance greater than a distance threshold from a most recently added layer of the finite element mesh; simulating an additive manufacturing build of the object based on the finite element mesh including the homogenized one or more lower layers, wherein a length of a homogenized element in the homogenized one or more lower layers is greater than a maximum element length in the finite element mesh prior to homogenization, and the distance threshold is a positive real number.

(2) The method of (1), wherein the homogenizing includes homogenizing the one or more lower layers when the one or more lower layers are located at a distance greater than 2^{N}xb from the most recently added layer of the finite element mesh, wherein N is a positive integer, b is a positive integer, and x is a length of a smallest element in the finite element mesh prior to homogenization.

(3) The method of (1) to (2), further comprising defining the maximum element length in the finite element mesh to be 2^{N}x.

(4) The method of (1) to (3), further comprising setting N to be a maximum number of coarsening generations.

(5) The method of (1) to (4), further comprising determining the maximum element length in the finite element mesh prior to homogenization based on a structure of the object.

(6) The method of (1) to (5), wherein the simulating of the additive manufacturing build includes determining the thermal response or the mechanical response of the object.

(7) The method of (1) to (6), wherein the homogenizing includes coarsening elements of the one or more lower layers so that the homogenized one or more lower layers have a lower feature resolution than the one or more lower layers prior to homogenization.

(8) An apparatus for predicting a thermal response, a mechanical response, and/or failure points in additive manufacturing, the apparatus comprising processing circuitry configured to generate a first layer of a finite element mesh of an object based on a three-dimensional model of the object, generate one or more additional layers of the finite element mesh of the object, homogenize one or more lower layers of the finite element mesh when the one or more lower layers are located at a distance greater than a distance threshold from a most recently added layer of the finite element mesh, and simulate an additive manufacturing build of the object based on the finite element mesh including the homogenized one or more lower layers, wherein a length of a homogenized element in the homogenized one or more lower layers is greater than a maximum element length in the finite element mesh prior to homogenization, and the distance threshold is a positive real number.

(9) The apparatus of (8), wherein the processing circuitry is further configured to homogenize the one or more lower layers when the one or more lower layers are located at a distance greater than 2^{N}xb from the most recently added layer of the finite element mesh, wherein N is a positive integer, b is a positive integer, and x is a length of a smallest element in the finite element mesh prior to homogenization.

(10) The apparatus of (8) to (9), wherein the processing circuitry is further configured to define the maximum element length in the finite element mesh as 2^{N}x.

(11) The apparatus of (8) to (10), wherein the processing circuitry is further configured to set N to be a maximum number of coarsening generations.

(12) The apparatus of (8) to (11) wherein the processing circuitry is further configured to determine the maximum element length in the finite element mesh prior to homogenization based on a structure of the object.

(13) The apparatus of (8) to (12), wherein the processing circuitry is further configured to simulate the additive manufacturing build by determining the thermal response or the mechanical response of the object.

(14) The apparatus of (8) to (13), wherein the processing circuitry is further configured to homogenize the one or more lower layers by coarsening elements in the one or more lower layers so that the homogenized one or more lower layers have a lower feature resolution than the one or more lower layers prior to homogenization.

(15) A non-transitory computer-readable storage medium for storing computer readable instructions that, when executed by a computer, cause the computer to perform a method of predicting a thermal response, a mechanical response, and/or failure points in additive manufacturing, the method comprising: generating a first layer of a finite element mesh of an object based on a three-dimensional model of the object; generating one or more additional layers of the finite element mesh of the object; homogenizing one or more lower layers of the finite element mesh when the one or more lower layers are located at a distance greater than a distance threshold from a most recently added layer of the finite element mesh; simulating an additive manufacturing build of the object based on the finite element mesh including the homogenized one or more lower layers, wherein a length of a homogenized element in the homogenized one or more lower layers is greater than a maximum element length in the finite element mesh prior to homogenization, and the distance threshold is a positive real number.

(16) The non-transitory computer-readable storage medium of (15), wherein the homogenizing includes homogenizing the one or more lower layers when the one or more lower layers are located at a distance greater than 2^{N}xb from the most recently added layer of the finite element mesh, wherein N is a positive integer, b is a positive integer, and x is a length of a smallest element in the finite element mesh prior to homogenization.

(17) The non-transitory computer-readable storage medium of (15) to (16), wherein the method further comprises setting the maximum element length in the finite element mesh to be defined by 2^{N}x.

(18) The non-transitory computer-readable storage medium of (15) to (17), wherein the method further comprises setting N to be a maximum number of coarsening generations.

(19) The non-transitory computer-readable storage medium of (15) to (18), wherein the simulating of the additive manufacturing build includes determining the thermal response or the mechanical response of the object.

(20) The non-transitory computer-readable storage medium of (15) to (19), wherein the homogenizing includes coarsening elements of the one or more lower layers so that the homogenized one or more lower layers have a lower feature resolution than the one or more lower layers prior to homogenization.

Obviously, numerous modifications and variations of the present disclosure are possible in light of the above teachings. It is therefore to be understood that within the scope of the appended claims, the invention may be practiced otherwise than as specifically described herein.

1. A method of predicting a thermal response, a mechanical response, and/or failure points in additive manufacturing, the method comprising:
generating a first layer of a finite element mesh of an object based on a three-dimensional model of the object;
generating one or more additional layers of the finite element mesh of the object;
homogenizing one or more lower layers of the finite element mesh when the one or more lower layers are located at a distance greater than a distance threshold from a most recently added layer of the finite element mesh;
simulating an additive manufacturing build of the object based on the finite element mesh including the homogenized one or more lower layers,
wherein a length of a homogenized element in the homogenized one or more lower layers is greater than a maximum element length in the finite element mesh prior to homogenization, and
the distance threshold is a positive real number.

2. The method of claim 1, wherein the homogenizing includes homogenizing the one or more lower layers when the one or more lower layers are located at a distance greater than 2^{N}xb from the most recently added layer of the finite element mesh, wherein N is a positive integer, b is a positive integer, and x is a length of a smallest element in the finite element mesh prior to homogenization.

3. The method of claim 2, further comprising defining the maximum element length in the finite element mesh to be 2^{N}x.

4. The method of claim 2, further comprising setting N to be a maximum number of coarsening generations.

5. The method of claim 1, further comprising determining the maximum element length in the finite element mesh prior to homogenization based on a structure of the object.

6. The method of claim 1, wherein the simulating of the additive manufacturing build includes determining the thermal response or the mechanical response of the object.

7. The method of claim 1, wherein the homogenizing includes coarsening elements of the one or more lower layers so that the homogenized one or more lower layers have a lower feature resolution than the one or more lower layers prior to homogenization.

8. An apparatus for predicting a thermal response, a mechanical response, and/or failure points in additive manufacturing, the apparatus comprising:
processing circuitry configured to
generate a first layer of a finite element mesh of an object based on a three-dimensional model of the object,
generate one or more additional layers of the finite element mesh of the object,
homogenize one or more lower layers of the finite element mesh when the one or more lower layers are located at a distance greater than a distance threshold from a most recently added layer of the finite element mesh, and
simulate an additive manufacturing build of the object based on the finite element mesh including the homogenized one or more lower layers,
wherein a length of a homogenized element in the homogenized one or more lower layers is greater than a maximum element length in the finite element mesh prior to homogenization, and
the distance threshold is a positive real number.

9. The apparatus of claim 8, wherein the processing circuitry is further configured to homogenize the one or more lower layers when the one or more lower layers are located at a distance greater than 2^{N}xb from the most recently added layer of the finite element mesh, wherein N is a positive integer, b is a positive integer, and x is a length of a smallest element in the finite element mesh prior to homogenization.

10. The apparatus of claim 9, wherein the processing circuitry is further configured to define the maximum element length in the finite element mesh as 2^{N}x.

11. The apparatus of claim 9, wherein the processing circuitry is further configured to set N to be a maximum number of coarsening generations.

12. The apparatus of claim 8, wherein the processing circuitry is further configured to determine the maximum element length in the finite element mesh prior to homogenization based on a structure of the object.

13. The apparatus of claim 8, wherein the processing circuitry is further configured to simulate the additive manufacturing build by determining the thermal response or the mechanical response of the object.

14. The apparatus of claim 8, wherein the processing circuitry is further configured to homogenize the one or more lower layers by coarsening elements in the one or more lower layers so that the homogenized one or more lower layers have a lower feature resolution than the one or more lower layers prior to homogenization.

15. A non-transitory computer-readable storage medium for storing computer readable instructions that, when executed by a computer, cause the computer to perform a method of predicting a thermal response, a mechanical response, and/or failure points in additive manufacturing, the method comprising:
generating a first layer of a finite element mesh of an object based on a three-dimensional model of the object;
generating one or more additional layers of the finite element mesh of the object;
homogenizing one or more lower layers of the finite element mesh when the one or more lower layers are located at a distance greater than a distance threshold from a most recently added layer of the finite element mesh;
simulating an additive manufacturing build of the object based on the finite element mesh including the homogenized one or more lower layers,
wherein a length of a homogenized element in the homogenized one or more lower layers is greater than a maximum element length in the finite element mesh prior to homogenization, and
the distance threshold is a positive real number.

16. The non-transitory computer-readable storage medium of claim 15, wherein the homogenizing includes homogenizing the one or more lower layers when the one or more lower layers are located at a distance greater than 2^{N}xb from the most recently added layer of the finite element mesh, wherein N is a positive integer, b is a positive integer, and x is a length of a smallest element in the finite element mesh prior to homogenization.

17. The non-transitory computer-readable storage medium of claim 16, wherein the method further comprises setting the maximum element length in the finite element mesh to be 2^{N}x.

18. The non-transitory computer-readable storage medium of claim 16, wherein the method further comprises setting N to be a maximum number of coarsening generations.

19. The non-transitory computer-readable storage medium of claim 15, wherein the simulating of the additive manufacturing build includes determining the thermal response or the mechanical response of the object.

20. The non-transitory computer-readable storage medium of claim 15, wherein the homogenizing includes coarsening elements of the one or more lower layers so that the homogenized one or more lower layers have a lower feature resolution than the one or more lower layers prior to homogenization.
